(19) United States
(12) Patent Application Publication
(10) Pub. No.: US 2015/0003549 A1
(43) Pub. Date: Jan. 1, 2015

(54) WIRELESS COMMUNICATIONS APPARATUS AND METHOD OF OPERATING THE SAME

(71) Applicant: SAMSUNG ELECTRO-MECHANICS CO., LTD., Suwon (KR)

(72) Inventors: Seong Yeon KIM, Suwon (KR); Sun Young YU, Suwon (KR)

(73) Assignee: SAMSUNG ELECTRO-MECHANICS CO., LTD., Suwon (KR)

(21) Appl. No.: 14/049,566

(22) Filed: Oct. 9, 2013

(30) Foreign Application Priority Data
Jun. 28, 2013 (KR) 10-2013-0076014

(51) Int. Cl. H04W 72/08; H04L 5/06; H04B 7/04

(52) U.S. Cl. CPC H04W 72/085; H04B 7/0413; H04L 5/06
USPC 375/267

(57) ABSTRACT

There is provided a wireless communications apparatus including a plurality of antennas transmitting data to and receiving data from a plurality of terminals; a reception unit connected to the plurality of antennas and receiving quality of service (QoS) type information and channel information with respect to the plurality of antennas from at least one of the plurality of terminals; a calculation unit calculating a signal-to-interference and noise ratio (SINR) value by using the channel information; an antenna distribution unit allocating an antenna to the at least one terminal by using the QoS type information and the SINR value; and a frequency allocation unit selectively allocating one of a plurality of pre-set frequency bandwidths to the antenna-allocated terminal by using at least one of the QoS type information and the channel information.

### CROSS-REFERENCE TO RELATED APPLICATION

This application claims the priority of Korean Patent Application No. 10-2013-0076014 filed on Jun. 28, 2013, with the Korean Intellectual Property Office, the disclosure of which is incorporated herein by reference.

### BACKGROUND OF THE INVENTION

1. Field of the Invention

The present invention relates to a wireless communications apparatus and a method of operating the same.

2. Description of the Related Art

A wireless communications device, e.g., an access point (AP), is a device for connecting wireless terminals to a wired device using Wi-Fi, a Bluetooth-related standard, or the like, on a computer network, which is also referred to as a wireless access point (WAP).

An AP, generally connected to a router that passes through a wired network, may relay data between wireless terminals such as smartphones, tablet PCs, computers, printers, and the like, and a wired device on a network, and here, wireless terminals may provide a user with various services such as a voice call service, a video streaming service, a data service, and the like, via an AP.

Meanwhile, a single AP may be wirelessly connected to a plurality of terminals and perform wireless communications therewith, according to priority differentiated depending on types of requested service.

For example, an AP may preferentially process an online game, a video call, a voice call, and the like, for which real-time data transmission is required, process a video streaming service undergoing buffering, or the like, as a next priority, and process a general data service in subsequent order.

The characteristics of services used as a reference standard for differentiating priority are generally known as quality of service (QoS).

In line therewith, a carrier sense multiple access/collision avoidance (CSMA/CA) scheme of adjusting a communications order, upon sensing carriers that use a medium before medium accessing, such that data communications collisions, on the basis of sensed carriers, may be prevented, has largely been used.

Namely, when a particular terminal requests communications with an AP, it determines whether a different terminal is currently communicating with the AP, in a CSMA/CA scheme, and is on standby. In this case, a waiting time for the corresponding terminal to request communications with the AP again may be classified as 1 ms in the case of a service requiring a real-time data transmission, 2 ms in the case of a video streaming service, 3 ms in the case of a general data service, and the like, according to QoS types, and wireless communications may be performed accordingly.

However, such a scheme may increases user waiting time for users who want to use different services, causing a problem in terms of fairness. Also, in the case of distributing data communications to enhance fairness, quality of services such as a voice call, a video call, and the like, requiring real-time data communications may be degraded.

In an effort to solve this problem, a multi-input multi-output (MIMO) scheme has been proposed.

MIMO is a scheme in which a plurality of antennas are installed at transmission and reception ends to increase channel capacity in a given bandwidth and respective transmission antennas transmit different transmission signals. With this scheme, a data rate gain and the channel capacity can be increased by as much as the number of transmission antennas, in comparison to an existing single-input single-output (SISO) scheme.

However, in spite of the application of the MIMO scheme, since the existing CSMA/CA scheme is still largely used, overall system channels cannot be utilized with optimized efficiency.

Patent document 1 relates to a MIMO wireless LAN system capable of obtaining high output and high throughput by using MIMO and orthogonal frequency division multiplexing (OFDM). Also, Patent document 2 relates to multi-user scheduling in a WLAN system.

However, unlike the present invention, Patent document 1 and Patent document 2 do not disclose content for enhancing frequency efficiency by flexibly allocating a frequency bandwidth to each user according to QoS type information.

### RELATED ART DOCUMENT

(Patent document 1) Korean Patent Laid-Open Publication No. 10-2005-0053787
(Patent document 2) U.S. Patent Application Publication No. 2011-0002227

### SUMMARY OF THE INVENTION

An aspect of the present invention provides a method for allocating a frequency bandwidth on the basis of information regarding QoS of a terminal and channel information to allow a wireless communications apparatus having a plurality of antennas and a plurality of terminals to perform high capacity, high quality wireless communications.

According to an aspect of the present invention, there is provided a wireless communications apparatus including: a plurality of antennas transmitting data to and receiving data from a plurality of terminals; a reception unit connected to the plurality of antennas and receiving quality of service (QoS) type information and channel information with respect to the plurality of antennas from at least one of the plurality of terminals; a calculation unit calculating a signal-to-interference and noise ratio (SINR) value by using the channel information; an antenna distribution unit allocating an antenna to the at least one terminal by using the QoS type information and the SINR value; and a frequency allocation unit selectively allocating one of a plurality of pre-set frequency bandwidths to the antenna-allocated terminal by using at least one of the QoS type information and the channel information.

The wireless communications apparatus may further include a determining unit connected to the reception unit and determining whether the number of terminals having provided the QoS type information and the channel information is plural when the QoS type information is a real-time communications service or a voice call service.

When the QoS type information is not a real-time communications service or a voice call service, one of the plurality of pre-set frequency bandwidths may be selectively allocated to the at least one terminal having provided the QoS type information and the channel information, by using at least one of the QoS type information and the channel information.

When the antenna-allocated terminal is in an uplink state, the frequency allocation unit may select a lowest pre-set frequency bandwidth.

The channel information may be included in a preamble of data transmitted between the plurality of terminals and the plurality of antennas.

The QoS type information may have priority in order of a real-time communications service, a voice call service, a video streaming service, and a data service.

The antenna distribution unit may classify the plurality of terminals according to the QoS type information to generate a plurality of terminal groups, and allocate a first antenna among the plurality of antennas to one terminal selected from a terminal group having highest priority QoS type information among the plurality of terminal groups.

The antenna distribution unit may allocate a second antenna among the plurality of antennas to a terminal having a highest SINR value, among remaining terminals unselected from the terminal group having the highest priority QoS type information.

According to another aspect of the present invention, there is provided a wireless communications apparatus including: a plurality of antennas transmitting data to and receiving data from a plurality of terminals; a reception unit connected to the plurality of antennas and receiving quality of service (QoS) type information and channel information with respect to the plurality of antennas from at least one of the plurality of terminals; a determining unit connected to the reception unit and determining whether the number of terminals having provided the QoS type information and the channel information is plural when the QoS type information is a real-time communications service or a voice call service; a weight generating unit generating weight priority by providing weights to the plurality of terminals according to the QoS type information when it is determined that the number of terminals having provided the QoS type information and the channel information is plural; an antenna distribution unit allocating the plurality of antennas to the plurality of terminals by using the weight priority; and a frequency allocation unit selectively allocating a plurality of pre-set frequency bandwidths to corresponding antenna-allocated terminals by using at least one of the QoS type information, the channel information, and the weight priority.

The QoS type information may have priority in order of a real-time communications service, a voice call service, a video streaming service, and a data service.

The weight generating unit may provide a first weight to the plurality of terminals according to priority of the QoS type information, a second weight according to the number of terminals having provided the QoS type information and the channel information, and generate the weight priority in order, starting from one having the greatest value among values obtained by multiplying the first weight and the second weight.

The wireless communications apparatus may further include a calculation unit calculating a signal-to-interference and noise ratio (SINR) value by using the channel information, and the antenna distribution unit may allocate the plurality of antennas to the plurality of terminals by further reflecting the SINR value.

When the antenna-allocated terminal is in an uplink state, the frequency allocation unit may select a lowest pre-set frequency bandwidth.

When the QoS type information is not a real-time communications service or a voice call service or when the number of terminals having provided the QoS type information and the channel information is one, the determining unit may selectively allocate one of the plurality of pre-set frequency bandwidths to the terminal by using at least one of the QoS type information and the channel information.

According to another aspect of the present invention, there is provided method of operating a wireless communications apparatus in a method for transmitting and receiving data between the wireless communications apparatus having a plurality of antennas and a plurality of terminals, the method including: receiving quality of service (QoS) type information and channel information with respect to the plurality of antennas from at least one of the plurality of terminals; calculating a signal-to-interference and noise ratio (SINR) value by using the channel information; allocating an antenna to the at least one terminal by using the QoS type information and the SINR value; and selectively allocating one of a plurality of pre-set frequency bandwidths to the antenna-allocated terminal by using at least one of the QoS type information and the channel information.

The channel information may be included in a preamble of data transmitted between the plurality of terminals and the plurality of antennas.

When the antenna-allocated terminal is in an uplink state, a lowest pre-set frequency bandwidth may be selected.

The method may further include determining whether the QoS type information is a real-time communications service or a voice call service in the wireless communications apparatus.

The method may further include selectively allocating one of the plurality of pre-set frequency bandwidths to the at least one terminal having provided the QoS type information and the channel information, by using at least one of the QoS type information and the channel information when the QoS type information is not the real-time communications service or the voice call service.

The method may further include determining whether the number of terminals having provided the QoS type information and the channel information is plural when the QoS type information is determined as the real-time communications service or the voice call service.

When the number of terminals having provided the QoS type information and the channel information is one, the method may further include selectively allocating one of the plurality of pre-set frequency bandwidths to the terminal by using at least one of the QoS type information and the channel information.

The allocating of the antenna may include classifying the plurality of terminals according to the QoS type information to generate a plurality of terminal groups; selecting a terminal from a terminal group having highest priority QoS type information among the plurality of terminal groups; allocating a first antenna, among the plurality of antennas, to the selected terminal; and allocating a second antenna, among the plurality of antennas, to a terminal having a highest SINR value, among remaining terminals unselected from the terminal group having the highest priority QoS type information.

Priority of the QoS type information may be given in order of a real-time communications service, a voice call service, a video streaming service, and a data service.

According to another aspect of the present invention, there is provided a method of operating a wireless communications apparatus in a method for transmitting and receiving data between the wireless communications apparatus having a plurality of antennas and a plurality of terminals, the method including: receiving quality of service (QoS) type information and channel information with respect to the plurality of antennas from the plurality of terminals; determining whether the QoS type information is a real-time call service or a voice call service; determining whether the number of terminals having provided the QoS type information and the channel information is plural when the QoS type information is determined as the real-time communications service or the voice call service; providing weights to the plurality of terminals according to the QoS type information to generate weight priority when it is determined that the number of terminals having provided the QoS type information and the channel information is plural; allocating the plurality of antennas to the plurality of terminals by using the weight priority; and selectively allocating a plurality of pre-set frequency bandwidths to corresponding antenna-allocated terminals by using at least one of the QoS type information, the channel information, and the weight priority.

The QoS type information may have priority in order of a real-time communications service, a voice call service, a video streaming service, and a data service.

In the generating of the weight priority, a first weight may be given to the plurality of terminals according to priority of the QoS type information, a second weight may be given according to the number of terminals having provided the QoS type information and the channel information, and the weight priority may be generated in order, starting from one having a greatest value among values obtained by multiplying the first weight and the second weight.

The method may further include calculating a signal-to-interference and noise ratio (SINR) value by using the channel information, and the plurality of antennas may be allocated to the plurality of terminals by further reflecting the SINR value.

When the antenna-allocated terminal is in an uplink state, a lowest pre-set frequency bandwidth may be selected.

When the QoS type information is not a real-time communications service or a voice call service or when the number of terminals having provided the QoS type information and the channel information is one, the method may further include selectively allocating one of the plurality of pre-set frequency bandwidths to the terminal by using at least one of the QoS type information and the channel information.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view schematically illustrating an operating method using a wireless communications apparatus according to an embodiment of the present invention;

FIG. 2 is a block diagram schematically illustrating a wireless communications apparatus according to an embodiment of the present invention;

FIG. 3 is a flowchart illustrating a method of operating a wireless communications apparatus according to an embodiment of the present invention;

FIG. 4 is a flowchart illustrating a method of operating a wireless communications apparatus according to an embodiment of the present invention;

FIG. 5 is a flowchart illustrating a method of operating a wireless communications apparatus according to an embodiment of the present invention;

FIG. 6 is a flowchart illustrating a method for allocating antennas illustrated in FIG. 3 according to an embodiment of the present invention; and

FIG. 7 is a flowchart illustrating a method for allocating antennas illustrated in FIGS. 4 and 5 according to an embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same or like reference numerals will be used to designate the same or like elements.

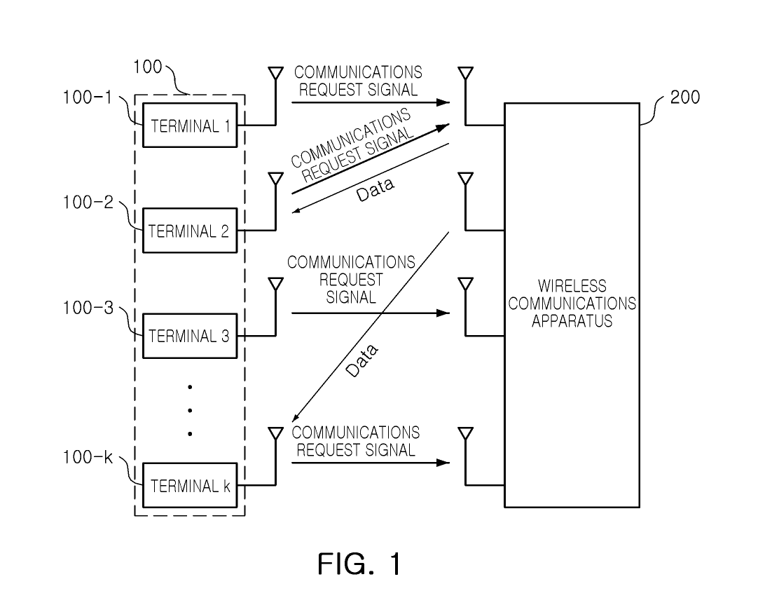

FIG. 1 is a view schematically illustrating an operating method using a wireless communications apparatus according to an embodiment of the present invention.

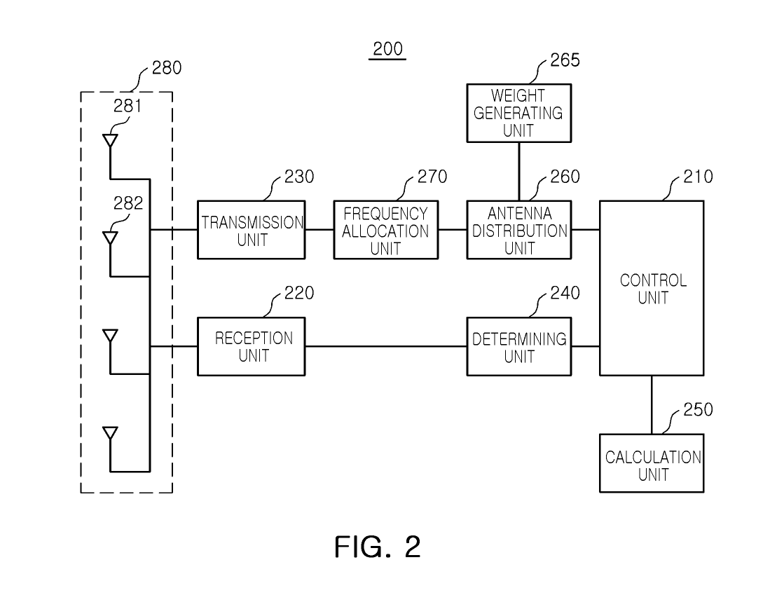

FIG. 2 is a block diagram schematically illustrating a wireless communications apparatus according to an embodiment of the present invention.

Referring to FIGS. 1 and 2, a method of operating a wireless communications apparatus according to an embodiment of the invention may include a wireless communications apparatus 200 having a plurality of antennas 280 and a plurality of terminals 100 (k is a natural number equal to or greater than 1 in FIG. 1) (hereinafter, a plurality of terminals will be denoted by reference numeral 100, and one thereof will be denoted by 100-1).

Each of the plurality of terminals 100 may be a smartphone, a tablet PC, a notebook, a computer, various computer peripherals, and the like, and may form a communications channel with at least one of the antennas 280 of the wireless communications apparatus 200 to transmit and receive data.

Here, at least one terminal 100-1, among the plurality of terminals 100, may provide a communications request signal, including information regarding a required QoS type (or QoS type information) and information regarding channels of the at least one terminal 100-1 with respect to the plurality of antennas 280 of the wireless communications apparatus 200 (or channel information), to the wireless communications apparatus 200.

Referring to FIG. 2, the wireless communications apparatus 200 may include a control unit 210, a reception unit 220, a transmission unit 230, a determining unit 240, a calculation unit 250, an antenna distribution unit 260, a frequency allocation unit 270, and a plurality of terminals 280.

The reception unit 220 may be connected to the plurality of antennas 280 to receive QoS type information and channel information of the terminals 100 with respect to the plurality of antennas 280 of the wireless communications apparatus 200.

The determining unit 240 may be connected to the reception unit 220 and determine whether the QoS type information is a real-time communications service or a voice call service. Also, when the QoS type information is a real-time communications service or a voice call service, the determining unit 240 may determine whether the communications request signal has been received from the plurality of terminals 100.

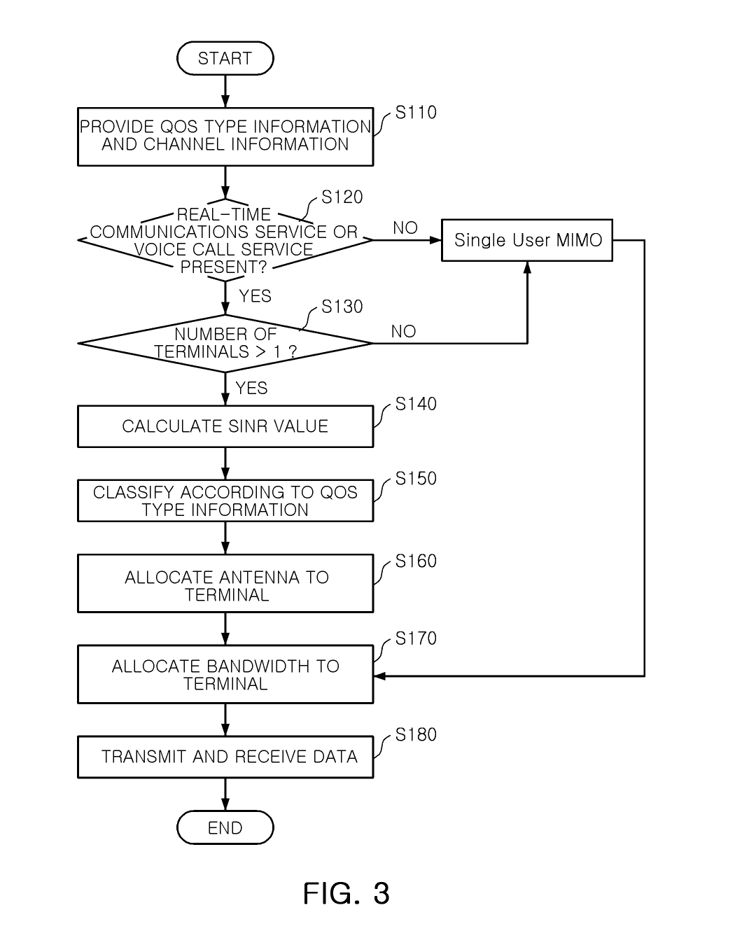

If the QoS type information is not a real-time communications service or a voice call service, one of a plurality of pre-set frequency bandwidths may be selectively allocated to the terminal 100-1, which has provided the QoS type information and the channel information with respect to the plurality of antennas 280, by using at least one of the QoS type information and the channel information (please see FIG. 3).

Also, even when the QoS type information is a real-time communications service or a voice call service, one of the plurality of pre-set frequency bandwidths may be selectively allocated to the terminal 100-1, which has provided the QoS type information and the channel information with respect to the plurality of antennas 280, by using at least one of the QoS type information and the channel information (please see FIG. 3).

The calculation unit 250 may calculate a signal-to-interference and noise ratio (SINR) by using the information regarding the channels of the terminal 100-1 with respect to the plurality of antennas 280 of the wireless communications apparatus 200.

Also, the channel information may be included in a preamble of data transmitted between the terminal 100-1 and the wireless communications apparatus 200, and the wireless communications apparatus 200 may derive a channel transfer function from the preamble, derive a channel matrix from the channel transfer function, and calculate an SINR value by using the channel matrix.

Here, the channel matrix Hi may be expressed by a determinant as follows.

$${H}_{i} = [ \begin{matrix}{h}_{11}^{i} & … & {h}_{1 {M}_{T}}^{i} \\ ⋮ & ⋱ & ⋮ \\ {h}_{{M}_{R} 1}^{i} & … & {h}_{{M}_{R} {M}_{T}}^{i}\end{matrix} ] \qquad [ Determinant 1 ]$$

hi: i-th Channel Transfer Function

MT: Number of Antennas 280 of Wireless Communications Apparatus 200

MR: Number of Terminals 100-1

Also, the SINR may also be calculated using Equation 1 below.

$${SINR}_{i} = \frac{{1}^{- 1}}{[ {( I + \frac{1}{{M}_{T}} H + H )}^{- 1} ]} \qquad [ Equation 1 ]$$

H: Channel Matrix

H+: Hermitian Matrix of H

MT: Number of Antennas 280 of Wireless Communications Apparatus 200

I: Unit Matrix

Meanwhile, the antenna distribution unit 260 may allocate the antennas 280 to at least one or more terminals by using the QoS type information and the SINR value.

In detail, the antenna distribution unit 260 may generate a plurality of terminal groups by classifying the at least one or more terminals, which have transmitted the QoS type information and the channel information, according to QoS type information. Among them, the antenna distribution unit 260 may select one terminal 100-1 from a terminal group having the highest priority of the QoS type information, and allocate a first antenna 281 among the plurality of antennas 280 to the terminal 100-1.

Thereafter, the antenna distribution unit 260 may allocate a second antenna 282 among the plurality of antennas 280 to a terminal 100-2 having the highest SINR value, among the remaining terminals which have not been selected, in the group having the highest priority of the QoS type information.

Here, the priority of the QoS type information may be a real-time communications service, a voice call service, a video streaming service, and a general data service in this order.

Meanwhile, the frequency allocation unit 270 may be positioned between the antenna distribution unit 260 and the plurality of antennas 280. The frequency allocation unit 270 may select one of the plurality of pre-set frequency bandwidths by using at least one of the QoS type information and the channel information and allocate the selected frequency bandwidth to the terminal 100-1 to which the antenna has been allocated.

In detail, a service requested by the antenna-allocated terminal may be identified according to the QoS type information and the channel information, and thus, the frequency allocation unit 270 may selectively allocate one of the plurality of pre-set frequency bandwidths according to a service requested by the terminal, rather than using a pre-set fixed frequency bandwidth.

For example, in a case in which a wireless computer networking standard is IEEE 802.11ac, 20 MHz, 40 MHz, 80 MHz, and 160 MHz may be set in advance as frequency bandwidths. In this case, when a service requested by the antenna-allocated terminal is a voice call service, the frequency allocation unit 270 may selectively allocate 20 MHz among the pre-set frequency bandwidths, and when a service requested by the antenna-allocated terminal is a video streaming service, the frequency allocation unit 270 may selectively allocate 80 MHz among the pre-set frequency bandwidths.

Namely, rather than using the same frequency bandwidth for each of the plurality of terminals 100, a frequency bandwidth may be varied for the terminal 100-1 given priority according to the QoS type information, whereby fairness of the terminal 100-1 may be maintained and data transmission and reception efficiency of the overall system may be increased.

Meanwhile, the frequency allocation unit 270 determines whether the antenna-allocated terminal 100-1 is in an up-link state, and when the antenna-allocated terminal 100-1 is in an up-link state, the frequency allocation unit 270 may select the lowest of the pre-set bandwidths. This is because a small amount of data is transmitted and received in the uplink state.

The wireless communications apparatus 200 according to the embodiment of the invention may further include a weight generating unit 265.

The weight generating unit 265 may provide a first weight to the plurality of terminal groups according to priority based on QoS type information, and a second weight according to the number of terminals belonging to each of the plurality of terminal groups.

Here, as priority according to the QoS type information is higher, a greater value may be given as the first weight, and as the number of terminals belonging to each of the plurality of terminal groups is greater, a greater value may be given as the second weight.

Thereafter, weight priority may be determined in order, starting from the greatest value among values obtained by multiplying the first weight and the second weight, and the plurality of antennas 280 may be allocated to the terminals in order, starting from the greatest weight priority.

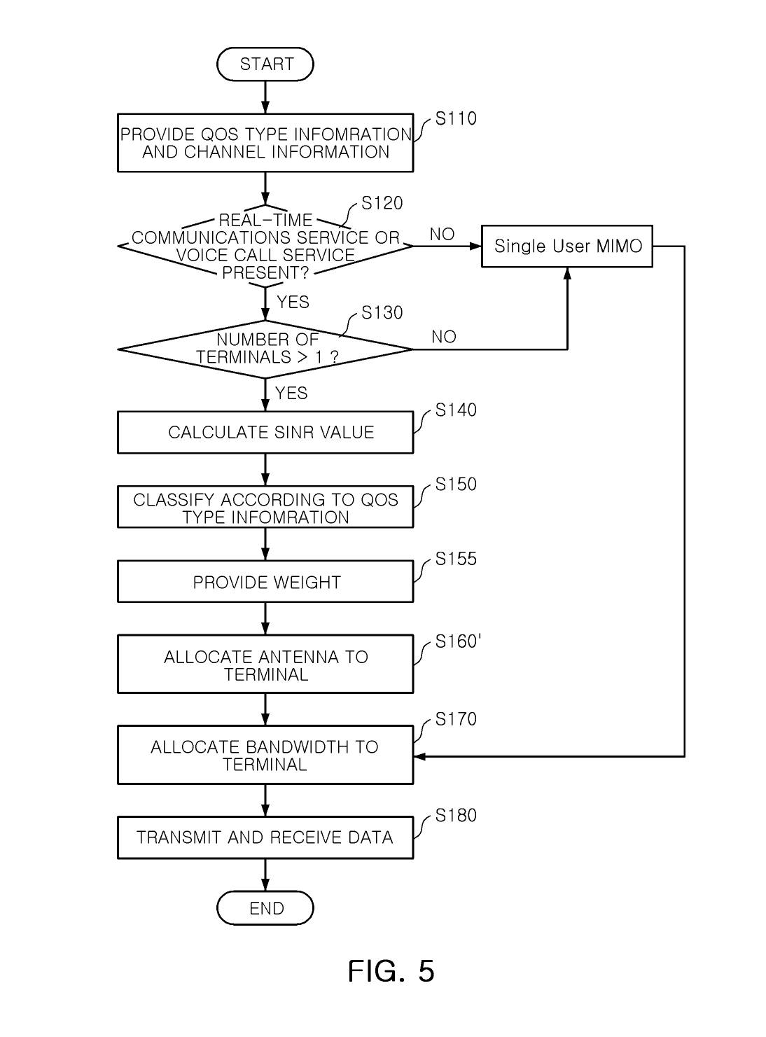

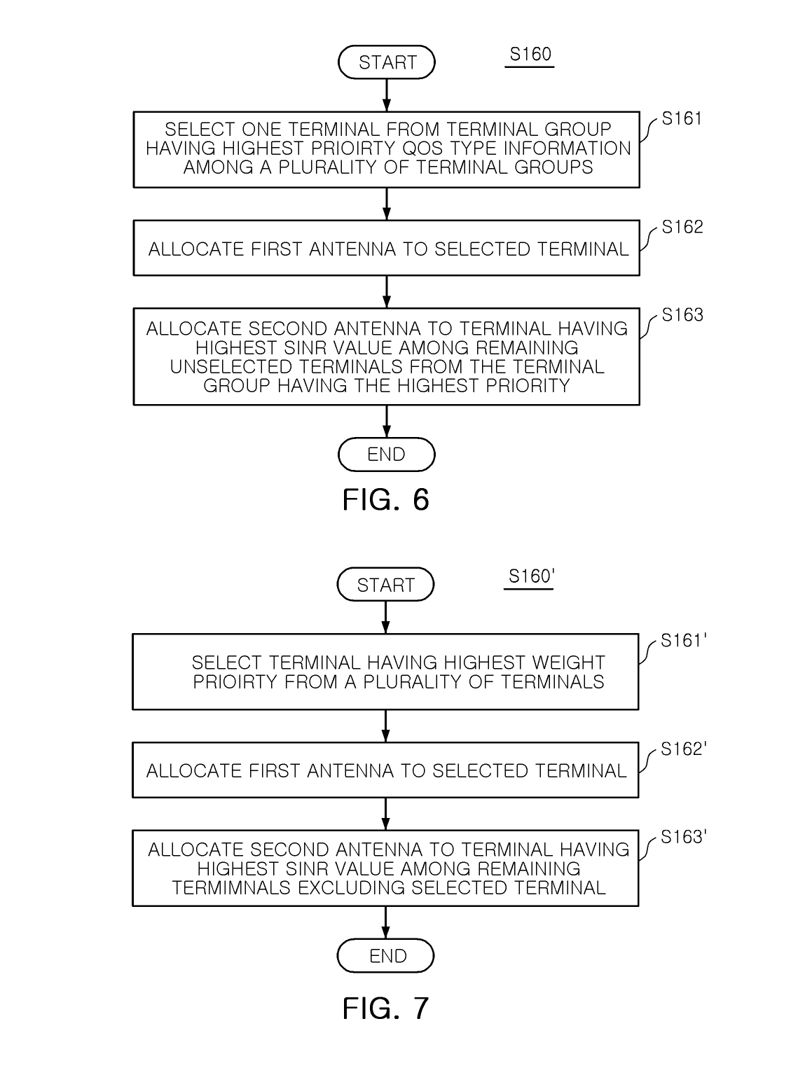

Meanwhile, the antenna distribution unit 260 may allocate the plurality of antennas 280 by further reflecting the weight priority generated by the weight generating unit 265. This will be described later in relation to FIGS. 5 and 6.

The determining unit 240, the calculation unit 250, the antenna distribution unit 260, the weight generating unit 265, and the frequency allocation unit 270 may be connected to the control unit 210 so as to be controlled.

FIG. 3 is a flowchart illustrating a method of operating a wireless communications apparatus according to an embodiment of the present invention.

FIG. 6 is a flowchart illustrating a method for allocating antennas illustrated in FIG. 3 according to the embodiment of the present invention.

Referring to FIGS. 3 and 6, a method of operating a wireless communications apparatus according to an embodiment of the present invention may include: receiving QoS type information and channel information with respect to the plurality of antennas 280 from at least one terminal 100-1 among the plurality of terminals 100 (S110); calculating an SINR value by using the channel information (S140); allocating the antenna 280 to the at least one terminal 100-1 by using the QoS type information and the SINR value (S160); and selectively allocating one of pre-set frequency bandwidths to the antenna-allocated terminal 100-1 by using at least one of the QoS type information and the channel information (S170).

Also, the method of operating the wireless communications apparatus 200 may further include determining whether the QoS type information is a service requiring real-time communications or a voice call service in the wireless communications apparatus 200 (S120).

Also, when the QoS type information is a service requiring real-time communications or a voice call service, the method may further include determining whether the number of terminals 100-1 is one or more when the QoS type information is a service requiring real-time communications or a voice call service (S130).

First, the QoS type information and the channel information with respect to the plurality of antennas may be received from the at least one terminal 100-1 among the plurality of terminals 100 (S110). Here, priority of the QoS type information may be a real-time communications service, a voice call service, a video streaming service, and a data service in this order. Also, the channel information may be included in a preamble of data transmitted between the plurality of terminals 100 and the plurality of antennas 280, and it may be utilized for a SINR calculation as described above.

The wireless communications apparatus 200 may determine whether the QoS type information is a service requiring real-time communications or a voice call service (S120). Here, when the QoS type information is not a service requiring real-time communications such as a video streaming service or a data service, the wireless communications apparatus 200 may selectively allocate one of a plurality of pre-set frequency bands to the terminal 100-1, which has provided the QoS type information and the channel information with respect to the plurality of antennas 280, by using at least one of the QoS type information and the channel information (please see FIG. 3).

Thereafter, when the QoS type information is a service requiring real-time communications or a voice call service, the wireless communications apparatus 200 determines whether the number of terminals, which have provided the QoS type information and the channel information, is plural (S130).

Here, when the number of terminals 100-1 is one, the wireless communications apparatus 200 may selectively allocate one of the plurality of pre-set frequency bandwidths to the terminal 100-1, which has provided the QoS type information and the channel information, by using at least one of the QoS type information and the channel information (please see FIG. 3).

Thereafter, when the number of terminals 100-1 is plural, the wireless communications apparatus 200 may calculate an SINR value from the channel information (S140). Here, a method for calculating the SINR value has been described, so a description thereof will be omitted.

Thereafter, the wireless communications apparatus 200 classifies the terminals, which have provided the QoS type information and the channel information, according to the QoS type information to generate a plurality of terminal groups (S150). Thereafter, the wireless communications apparatus 200 may allocate the antennas 280 to the terminals (S160). This will be described in detail with reference to FIG. 6.

Referring to FIG. 6, the wireless communications apparatus 200 may select one terminal 100-1 among the terminals belonging to a terminal group having the highest priority according to priority of the QoS type information, among the plurality of terminal groups classified according to the QoS type information, and allocate the first antenna 281 thereto.

Thereafter, the wireless communications apparatus 200 may select a terminal 100-2 having the highest SINR value calculated in operation 5140 with respect to the second antenna 282 selected from among the antennas excluding the first antenna 281 among the plurality of antennas 280 provided in the wireless communications apparatus 200, and allocate the second antenna 282 thereto.

Thereafter, referring back to FIG. 3, the wireless communications apparatus 200 may selectively allocate one of the plurality of pre-set frequency bandwidths to the antenna-allocated terminal 100-1 by using at least one of the QoS type information and the channel information (S170).

In detail, a service requested by the antenna-allocated terminal may be identified according to the QoS type information and the channel information, and thus, the wireless communications apparatus 200 may selectively allocate one of the plurality of pre-set frequency bandwidths according to a service requested by the terminal 100-1, rather than using a pre-set fixed frequency bandwidth.

Details thereof have been described above, so a description thereof will be omitted.

Namely, rather than using the same frequency bandwidth for each terminal, a frequency bandwidth may be varied for the terminal 100-1 given priority according to the QoS type information, whereby fairness of the terminal 100-1 may be maintained and data transmission and reception efficiency of the overall system may be increased.

Meanwhile, the selectively allocating of one of the plurality of pre-set frequency bandwidths may include determining whether the antenna-allocated terminal 100-1 is in an up-link state, and selecting the lowest of the pre-set frequency bandwidths when the antenna-allocated terminal 100-1 is in an up-link state. This is because a small amount of data is transmitted and received in the uplink state,

By iteratively performing the above-described process, the wireless communications apparatus 200 may allocate the antennas 280 and the frequency bandwidths to all the terminals which have transmitted the QoS type information and the channel information.

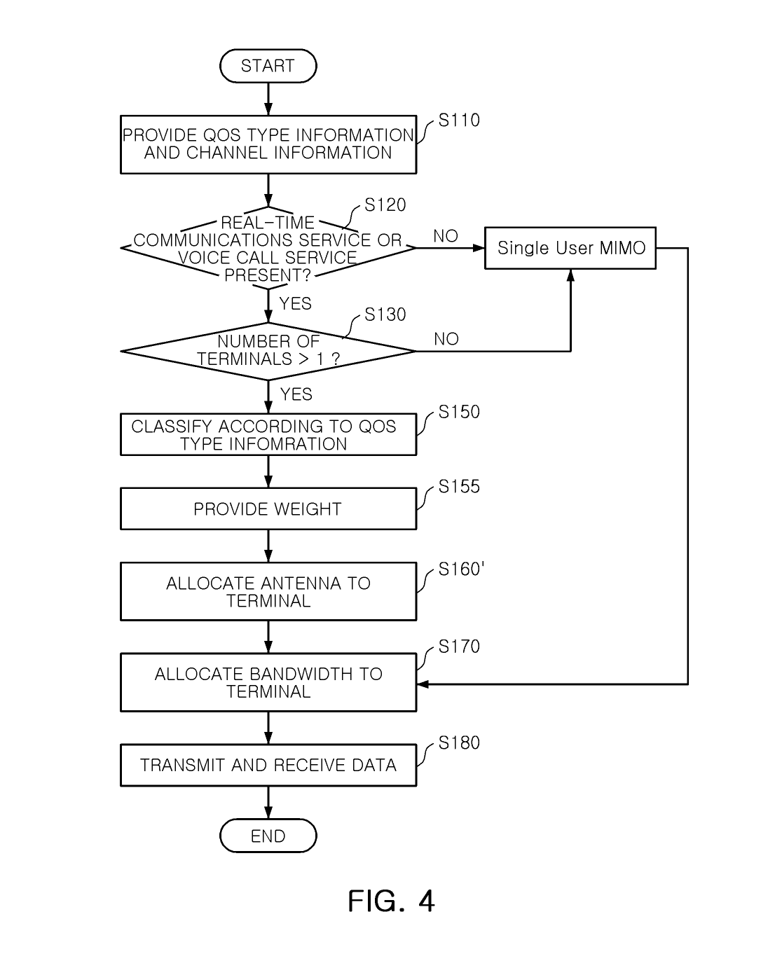

FIG. 4 is a flowchart illustrating a method of operating a wireless communications apparatus according to another embodiment of the present invention.

Referring to FIG. 4, a method of operating a wireless communications apparatus according to another embodiment of the present invention relates to a method for allocating the plurality of antennas 280 to the plurality of terminals 100 by using a first weight according to QoS type information and a second weight according to the number of terminals belonging to a terminal group, i.e., the number of terminals on a waiting list

The process described in operations 5110 to 5130 are the same as those described above, so a description thereof will be omitted.

Thereafter, the first weight is given according to priority based on QoS types, and the second weight may be given according to the number of terminals belonging to each terminal group (S155).

Here, as priority according to the QoS type information is higher, the first weight may have a greater value, and as the number of terminals belonging to a corresponding group is greater, the second weight may have a greater value. Thereafter, weight priority may be provided in order, starting from the greatest value among values obtained by multiplying the first weight and the second weight (S155).

The plurality of antennas 280 may be allocated to the plurality of terminals 100 by using the weight priority (S160′).

In addition, one of the pre-set frequency bandwidths may be selected by using at least one of the QoS type information, the channel information, and the weight priority and allocated to the antenna-allocated terminal.

Accordingly, high capacity high quality data transmission and reception may be performed, and unfairness that a particular terminal should wait excessively may be alleviated.

FIG. 5 is a flowchart illustrating a method of operating a wireless communications apparatus according to another embodiment of the present invention.

FIG. 7 is a flowchart illustrating a method for allocating the antennas illustrated in FIGS. 4 and 5 according to another embodiment of the present invention.

Referring to FIG. 5, a method of operating a wireless communications apparatus according to another embodiment of the present invention relates to a method for reflecting an SINR value in the antenna allocation (S160′) in the embodiment of FIG. 4 as described above.

Namely, referring to FIGS. 5 and 7, the wireless communications apparatus 200 may calculate an SINR value by using channel information, and the SINR value may be reflected in a process of allocating the second antenna 282 after the first antenna 281 is allocated to the terminal 100-1 having the highest weight priority in the process of allocating the terminals to the antennas (S160′).

In other words, the terminal 100-1 having the highest weight priority may be selected from among the plurality of terminal groups (S161′), and the first antenna 281 may be allocated to the selected terminal. Thereafter, the second antenna 282 may be selectively allocated to the terminal 100-2 having the highest SINR value among the other remaining terminals excluding the terminal 100-1 to which the first antenna 281 was allocated.

As set forth above, in the case of the wireless communications apparatus and the method of operating the same according to an embodiment of the present invention, since frequency bandwidths can be varied according to terminals, while maintaining an existing system guaranteeing QoS, a waiting time for the plurality of terminals connected to the wireless communications apparatus can be minimized, and thus, overall system efficiency can be improved.

In addition, in the case of the wireless communications apparatus and the method of operating the same according to an embodiment of the present invention, since frequency bandwidths are allocated to respective terminals, fairness of data communications can be enhanced.

While the present invention has been shown and described in connection with the embodiments, it will be apparent to those skilled in the art that modifications and variations can be made without departing from the spirit and scope of the invention as defined by the appended claims.

What is claimed is:

1. A wireless communications apparatus comprising:
a plurality of antennas transmitting data to and receiving data from a plurality of terminals;
a reception unit connected to the plurality of antennas and receiving quality of service (QoS) type information and channel information with respect to the plurality of antennas from at least one of the plurality of terminals;
a calculation unit calculating a signal-to-interference and noise ratio (SINR) value by using the channel information;
an antenna distribution unit allocating an antenna to the at least one terminal by using the QoS type information and the SINR value; and
a frequency allocation unit selectively allocating one of a plurality of pre-set frequency bandwidths to the antenna-allocated terminal by using at least one of the QoS type information and the channel information.

2. The wireless communications apparatus of claim 1, further comprising a determining unit connected to the reception unit and determining whether the number of terminals having provided the QoS type information and the channel information is plural when the QoS type information is a real-time communications service or a voice call service.

3. The wireless communications apparatus of claim 1, wherein when the QoS type information is not a real-time communications service or a voice call service, one of the plurality of pre-set frequency bandwidths is selectively allocated to the at least one terminal having provided the QoS type information and the channel information, by using at least one of the QoS type information and the channel information.

4. The wireless communications apparatus of claim 1, wherein when the antenna-allocated terminal is in an uplink state, the frequency allocation unit selects a lowest pre-set frequency bandwidth.

5. The wireless communications apparatus of claim 1, wherein the channel information is included in a preamble of data transmitted between the plurality of terminals and the plurality of antennas.

6. The wireless communications apparatus of claim 1, wherein the QoS type information has priority in order of a real-time communications service, a voice call service, a video streaming service, and a data service.

7. The wireless communications apparatus of claim 6, wherein the antenna distribution unit classifies the plurality of terminals according to the QoS type information to generate a plurality of terminal groups, and allocates a first antenna among the plurality of antennas to one terminal selected from a terminal group having highest priority QoS type information among the plurality of terminal groups.

8. The wireless communications apparatus of claim 7, wherein the antenna distribution unit allocates a second antenna among the plurality of antennas to a terminal having a highest SINR value, among remaining terminals unselected from the terminal group having the highest priority QoS type information.

9. A wireless communications apparatus comprising:
a plurality of antennas transmitting data to and receiving data from a plurality of terminals;
a reception unit connected to the plurality of antennas and receiving quality of service (QoS) type information and channel information with respect to the plurality of antennas from at least one of the plurality of terminals;
a determining unit connected to the reception unit and determining whether the number of terminals having provided the QoS type information and the channel information is plural when the QoS type information is a real-time communications service or a voice call service;
a weight generating unit generating weight priority by providing weights to the plurality of terminals according to the QoS type information when it is determined that the number of terminals having provided the QoS type information and the channel information is plural;
an antenna distribution unit allocating the plurality of antennas to the plurality of terminals by using the weight priority; and
a frequency allocation unit selectively allocating a plurality of pre-set frequency bandwidths to corresponding antenna-allocated terminals by using at least one of the QoS type information, the channel information, and the weight priority.

10. The wireless communications apparatus of claim 9, wherein the QoS type information has priority in order of a real-time communications service, a voice call service, a video streaming service, and a data service.

11. The wireless communications apparatus of claim 10, wherein the weight generating unit provides a first weight to the plurality of terminals according to priority of the QoS type information, a second weight according to the number of terminals having provided the QoS type information and the channel information, and generates the weight priority in order, starting from one having the greatest value among values obtained by multiplying the first weight and the second weight.

12. The wireless communications apparatus of claim 9, further comprising a calculation unit calculating a signal-to-interference and noise ratio (SINR) value by using the channel information,
wherein the antenna distribution unit allocates the plurality of antennas to the plurality of terminals by further reflecting the SINR value.

13. The wireless communications apparatus of claim 9, wherein when the antenna-allocated terminal is in an uplink state, the frequency allocation unit selects a lowest pre-set frequency bandwidth.

14. The wireless communications apparatus of claim 9, wherein when the QoS type information is not a real-time communications service or a voice call service or when the number of terminals having provided the QoS type information and the channel information is one, the determining unit selectively allocates one of the plurality of pre-set frequency bandwidths to the terminal by using at least one of the QoS type information and the channel information.

15. A method of operating a wireless communications apparatus in a method for transmitting and receiving data between the wireless communications apparatus having a plurality of antennas and a plurality of terminals, the method comprising:
receiving quality of service (QoS) type information and channel information with respect to the plurality of antennas from at least one of the plurality of terminals;
calculating a signal-to-interference and noise ratio (SINR) value by using the channel information;
allocating an antenna to the at least one terminal by using the QoS type information and the SINR value; and
selectively allocating one of a plurality of pre-set frequency bandwidths to the antenna-allocated terminal by using at least one of the QoS type information and the channel information.

16. The method of claim 15, wherein the channel information is included in a preamble of data transmitted between the plurality of terminals and the plurality of antennas.

17. The method of claim 15, wherein when the antenna-allocated terminal is in an uplink state, a lowest pre-set frequency bandwidth is selected.

18. The method of claim 15, further comprising determining whether the QoS type information is a real-time communications service or a voice call service in the wireless communications apparatus.

19. The method of claim 18, further comprising selectively allocating one of the plurality of pre-set frequency bandwidths to the at least one terminal having provided the QoS type information and the channel information, by using at least one of the QoS type information and the channel information when the QoS type information is not the real-time communications service or the voice call service.

20. The method of claim 18, further comprising determining whether the number of terminals having provided the QoS type information and the channel information is plural when the QoS type information is determined as the real-time communications service or the voice call service.

21. The method of claim 20, further comprising, when the number of terminals having provided the QoS type information and the channel information is one, selectively allocating one of the plurality of pre-set frequency bandwidths to the terminal by using at least one of the QoS type information and the channel information.

22. The method of claim 15, wherein the allocating of the antenna comprises:
classifying the plurality of terminals according to the QoS type information to generate a plurality of terminal groups;
selecting a terminal from a terminal group having highest priority QoS type information among the plurality of terminal groups;
allocating a first antenna, among the plurality of antennas, to the selected terminal; and
allocating a second antenna, among the plurality of antennas, to a terminal having a highest SINR value, among remaining terminals unselected from the terminal group having the highest priority QoS type information.

23. The method of claim 22, wherein priority of the QoS type information is given in order of a real-time communications service, a voice call service, a video streaming service, and a data service.

24. A method of operating a wireless communications apparatus in a method for transmitting and receiving data between the wireless communications apparatus having a plurality of antennas and a plurality of terminals, the method comprising:
receiving quality of service (QoS) type information and channel information with respect to the plurality of antennas from the plurality of terminals;
determining whether the QoS type information is a real-time call service or a voice call service;
determining whether the number of terminals having provided the QoS type information and the channel information is plural when the QoS type information is determined as the real-time communications service or the voice call service;
providing weights to the plurality of terminals according to the QoS type information to generate weight priority when it is determined that the number of terminals having provided the QoS type information and the channel information is plural;
allocating the plurality of antennas to the plurality of terminals by using the weight priority; and
selectively allocating a plurality of pre-set frequency bandwidths to corresponding antenna-allocated terminals by using at least one of the QoS type information, the channel information, and the weight priority.

25. The method of claim 24, wherein the QoS type information has priority in order of a real-time communications service, a voice call service, a video streaming service, and a data service.

26. The method of claim 25, wherein, in the generating of the weight priority, a first weight is given to the plurality of terminals according to priority of the QoS type information,
a second weight is given according to the number of terminals having provided the QoS type information and the channel information, and
the weight priority is generated in order, starting from one having a greatest value among values obtained by multiplying the first weight and the second weight.

27. The method of claim 24, further comprising calculating a signal-to-interference and noise ratio (SINR) value by using the channel information, and
the plurality of antennas are allocated to the plurality of terminals by further reflecting the SINR value.

28. The method of claim 24, wherein when the antenna-allocated terminal is in an uplink state, a lowest pre-set frequency bandwidth is selected.

29. The method of claim 24, further comprising, when the QoS type information is not a real-time communications service or a voice call service or when the number of terminals having provided the QoS type information and the channel information is one, selectively allocating one of the plurality of pre-set frequency bandwidths to the terminal by using at least one of the QoS type information and the channel information.
